(19) United States
(12) Patent Application Publication
(10) Pub. No.: US 2025/0289344 A1
(43) Pub. Date: Sep. 18, 2025

(54) Smart electric vehicle battery store and electric vehicle extra storage battery, for battery operated electric automobiles, battery operated electric vehicles, battery operated electric drones, battery operated electric airplanes, battery operated electric boats, battery operated electric devices, battery operated electric trucks, with a smart automatic mechanism to replace the drained battery with a fully charged one, or attach or detach an extra battery storage, on a slow moving or stationary

(71) Applicant: Navtej Singh Dhillon, Supply, NC (US)

(72) Inventor: Navtej Singh Dhillon, Supply, NC (US)

(21) Appl. No.: 19/079,414

(22) Filed: Mar. 13, 2025

Related U.S. Application Data
(60) Provisional application No. 63/564,939, filed on Mar. 13, 2024.

(51) Int. Cl. B60L 53/80

(52) U.S. Cl. CPC B60L 53/80; B60L 2200/10; B60L 2200/32; B60L 2200/36

(57) ABSTRACT

Intend to create a new smart electric vehicle battery store and electric vehicle extra storage battery, for battery operated electric automobiles, battery operated electric vehicles, battery operated electric drones, battery operated electric airplanes, battery operated electric boats, battery operated electric trucks which can significantly increase the range. Further intent to create a smart automatic mechanism replace and change battery or extra storage battery of the slow moving or stationary vehicle, doing this will allow a electric vehicle to get fully charged within seconds or minutes as comparable to “filling gas”.

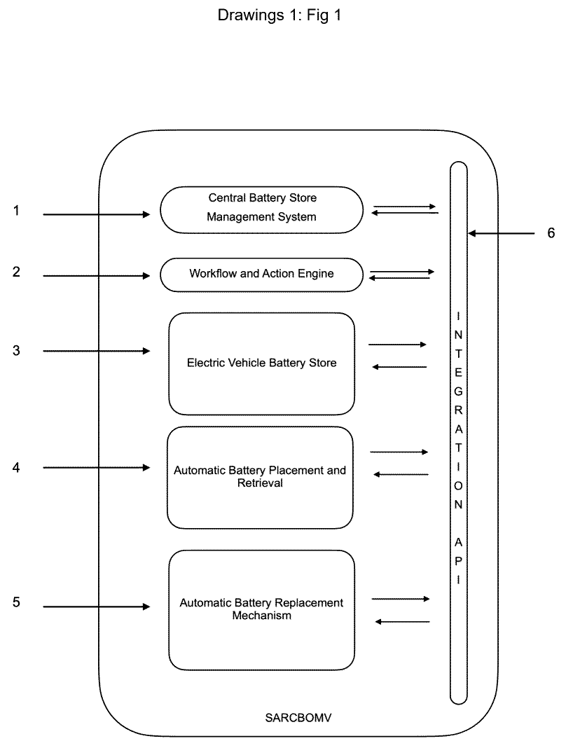

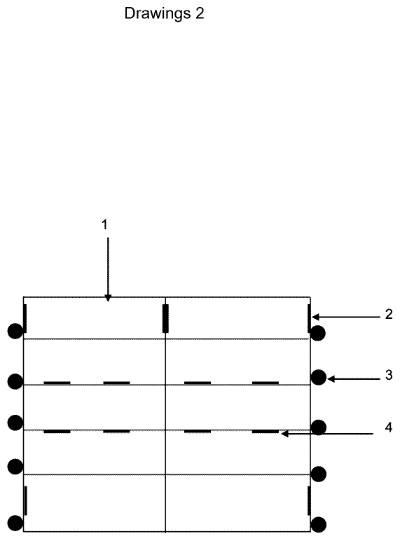

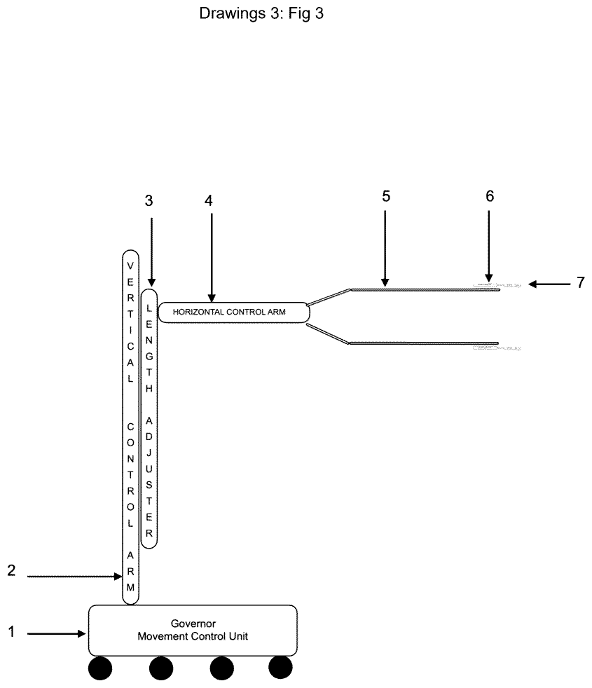

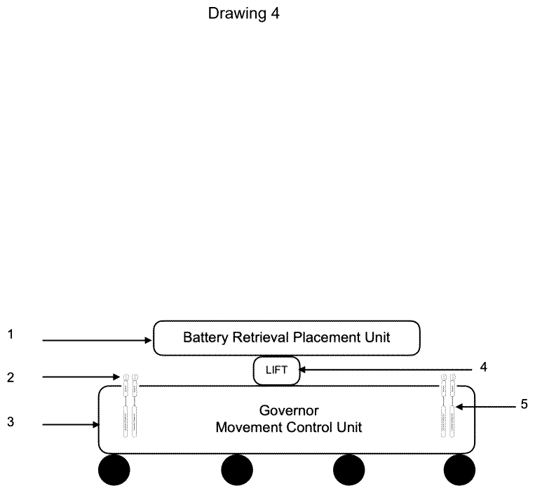

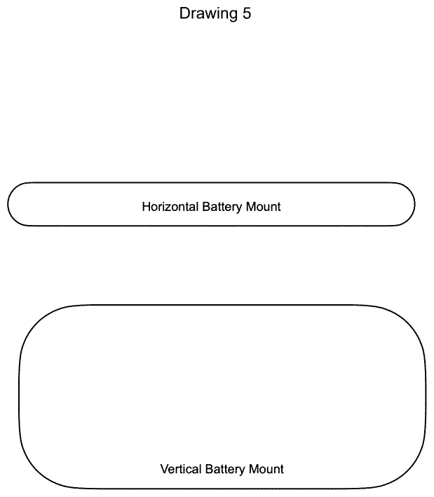

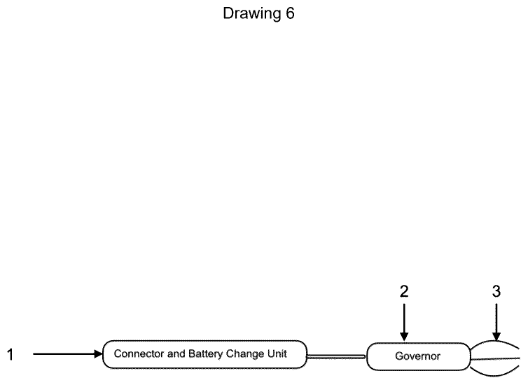

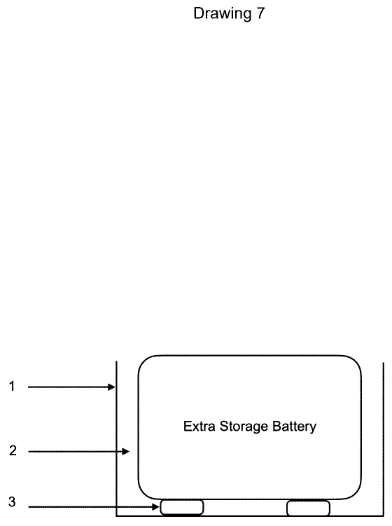

### CROSS-REFERENCE TO RELATED APPLICATIONS

Application No: 63/564,939

Application Title: Smart battery store and extra storage battery, for battery operated automobiles, battery operated vehicles, battery operated drones, battery operated airplanes, battery operated boats, etc, and with a smart automatic mechanism to replace the drained battery with a fully charged one, or attach or detach a extra battery storage, on a slow moving or stationary vehicle

Smart electric vehicle battery store and electric vehicle extra storage battery, for battery operated electric automobiles, battery operated electric vehicles, battery operated electric drones, battery operated electric airplanes, battery operated electric boats, battery operated electric devices, battery operated electric trucks, with a smart automatic mechanism to replace the drained battery with a fully charged one, or attach or detach an extra battery storage, on a slow moving or stationary vehicle.

### STATEMENT REGARDING FEDERALLY SPONSORED RESEARCH OR DEVELOPMENT (IF APPLICABLE)

S.1 No, None

### BACKGROUND OF THE INVENTION

B.1 Currently the range of the battery operated vehicles is limited, and it is impossible to take an electric vehicle or drone etc, on long trips without considerable thinking and planning on how to manage the battery charge and plan a route which can support the charging.

B.2 As of today, charging the batteries take significant amount of time, no mechanism exists as of today which can get the vehicle to its full range within seconds or minutes, there is nothing like a “gas station”, though there are electric “recharge” stations but they take significant amount of downtime for the vehicle and also the batteries are not 100% charged, without spending a considerable amount of time.

B.3 It is very hard for an electric vehicle to go off road and into the wilderness, where the infrastructure to recharge might not exist.

B.4 To achieve something like a fully recharge the battery of the moving vehicle some of the proposed solutions might not be realistic at all.

### BRIEF SUMMARY OF THE INVENTION

B.1 The idea is to create smart electric vehicle battery store and electric vehicle extra storage battery, for battery operated electric automobiles, battery operated electric vehicles, battery operated electric drones, battery operated electric airplanes, battery operated electric boats, battery operated electric devices, which can significantly increase the range, and with a smart automatic mechanism to replace the drained battery with a fully charged one, or attach or detach an extra battery storage, on a slow moving or stationary vehicle.

B.2 As detailed in the description, using this novel and innovative technology, this invention will remove the short comings of the electric vehicles or drones etc, with respect to its range of travel and how fast they get charged.

B.3 Extra storage battery can be utilized on need basis using the battery store, and a typical use case might be to use it at the start of the long trip and give it back at the end of the trip.

B.4 It will be possible for the electric vehicles to have a much longer range, and based on the range selected, right extra storage battery can be automatically attached.

B.5 Using the extra battery storage it will be possible to take off road trips and venture into the areas which do not have the required infrastructure of electric recharging.

B.6 It will be possible for the vehicle to get fully charged and back on road within seconds or minutes. As detailed in the description it will be possible to replace the drained battery of a slow moving vehicle or drone etc also.

B.7 The existing infrastructure of the “gas stations” can be used as such, and with slight modifications, it can service the electric vehicles or drones etc, of all makes and kinds.

B.8 The smart battery store will have all kinds of batteries and extra storage batteries where anybody can readily come in and take advantage of.

B.9 The battery store will be particularly useful for to be created battery operated heavy machines, battery operated trucks, battery operated long range vehicles, battery operated drones, battery operated airplanes and battery operated boats.

### BRIEF DESCRIPTION OF THE SEVERAL VIEWS OF THE DRAWING

DW.1 Drawing 1: Smart electric vehicle battery store (SBS) and system.

DW.1.1 Drawing 1: Shows, smart electric vehicle battery store (SBS) and system, further as duplicated in section D.1.

DW.1.2 1 “Central Battery Store Management System”, comprises of computer logic and system programming, for the complete system and provides the complete overview of the system. Further as described in section D.1

DW.1.3 2 “Workflow and Action Engine”, the workflow and action engine holds the workflow of battery retrieval and placement unit, and the workflow of battery attachment, detachment unit, it also holds the sets as actions which needs to be performed by the unit to complete the action. Based on the workflow based on the vehicle and job, exacts steps are sent to automatic battery retrieval and placement to pick the right battery and replace it in the vehicle, drone or boat. Further as depicted in section D.1

DW.1.4 3 is “Electric Vehicle Battery Store”, is the typical storage unit which holds the electric batteries, further as described in the diagram 2 below, the store has logical computation also which governs, the chaining of the batteries, the health of the batteries and other metrics.

DW.1.5 4 is “Automatic Battery Placement and Retrieval”, this sub system is responsible for automatic placement of the battery in the battery store and the automatic retrieval of the battery from the battery store, further the sub unit is responsible for detaching the battery or extra storage battery to electric vehicles, electric trucks, other electric devices, it relies on the central system for workflow and exact steps, configuration. Further as described in Diagram 3 and section D.5.

DW.1.6 5 is “Automatic Battery Replacement Mechanism” is sub system is responsible for detaching the battery or extra storage battery to electric vehicles, electric trucks, other electric devices, it is special in a way it can operate on slow moving vehicles also.

DW.1.7 6 is “Integration API”, the central API which all the systems use to interact with one another, further all the individual sub systems do expose APIs about their functionality, stats and working.

DW.2 Drawing 2: Example electric Vehicle Battery Store for storage electric vehicle batteries and extra storage batteries.

DW.2.1 Drawing 2: Shows, example electric Vehicle Battery Store for storage electric vehicle batteries and extra storage batteries. A battery store is normally hosted in a building, floating platform or boat, large sized locomotive and is made of smaller compartments, where an example compartment section is described here. Further as described in D.2.

DW.2.2 1 is “Battery Holder and Charging Compartments” these are modular design compartments which holds the batteries as they charge up, they can be of different size and shapes as defined by the size and shapes of the batteries.

DW.2.3 2 “Vertical Connectors”, are the vertical connectors for the batteries to connect on to.

DW.2.4 3 “Governor” is the logical electric unit which controls the charge of the battery, inventory of the slot, the connector types, battery types, voltage step up, step down, ampere, voltage and battery charging status, battery health.

DW.2.5 4 “Horizontal Connectors”, are the vertical connectors for the batteries to connect on to.

DW.3 Drawing 3: Automatic battery retrieval and placement, for retrieval, placement of batteries from the battery store and attaching, detaching the batteries to the vehicles.

DW.3.1 Drawing 3: Shows automatic Battery Placement and Retrieval unit which is responsible for automatic placement of the battery in the battery store and the automatic retrieval of the battery from the battery store, further the sub unit is responsible for detaching the battery or extra storage battery to electric vehicles, electric trucks, other electric devices.

DW.3.2 1 “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it. The governor receives the instructions based on the current workflow, and has exact series of steps to follow to complete the job. This unit is equipped with laser for exact positioning and movement.

DW.3.3 2 “Vertical Control Arm”, is the vertical control arm which moves the assembly up and down, and on its axis. It uses the technology that exists as of today for similar vertical movement arms, using hydraulics, and line wires.

DW.3.4 3 “Length Adjuster”, is the vertical control arm extension which can further adjust the length and increase the vertical reach.

DW.3.5 4 “Horizontal Control Arm”, is the horizontal control arm which can move the assembly to and fro horizontally.

DW.3.6 5 “Object Fork”, control fork which move, hold, place, objects, batteries, both in the battery store, and use the attached units to connect to the connectors and at the same time attach or detach to the vehicle.

DW.6.7 6: “Adjustable and sliding tightening mechanism”, is mechanism comprising of adjustable screws for tightening, it can operate while the “object fork” holds an object in a certain position.

DW.6.8 7: “Connector and Battery change unit”, is the control mechanism which can change a connector or battery unit.

DW.4 Drawing 4: Automatic battery replacement for stationary or slow moving vehicles, attaching, detaching the batteries to the vehicles.

DW.4.1 Drawing 4: Shows, automatic battery replacement for stationary or slow moving vehicles, attaching, detaching the batteries to the vehicles, is sub system which is responsible for detaching the battery or extra storage battery to electric vehicles, electric trucks, other electric devices, it is special in a way it can operate on slow moving vehicles also.

DW.4.2 1: “Battery Retrieval Placement Unit” is responsible for holding the battery or extra storage battery unit and positioning it to either retrieve it or place it to, on the vehicles.

DW.4.3 2: “Connector and Battery change unit”, is the control mechanism which can change a connector or battery unit.

DW.4.4 3: “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it. The governor receives the instructions based on the current workflow, and has exact series of steps to follow to complete the job. The unit is specially equipped with the laser to adjust the speed on the sub unit to match the speed of the vehicle and change the battery on slow moving vehicle. This unit is equipped with laser for exact positioning and movement.

DW.4.5 4: is “Lift” which is hydraulic based lift mechanism which is used to lift up or down the the “Battery Retrieval Placement Unit”, to replace the battery or extra storage battery.

DW.4.6 5: “Adjustable and sliding tightening mechanism”, is mechanism comprising of adjustable screws for tightening, it can operate while the “object fork” holds an object a certain position.

DW.5 Drawing 5: Horizontal and vertical battery mount for the vehicles

DW.5.1 Drawing 5: Horizontal and vertical battery mount for the vehicles, are special mounts which makes the replacement of batteries much easy, and these are special case. There can be special specifications that a manufacturers need to adhere to be able to used for replaceable battery to be used by the vehicles. Broadly there are two types of battery mounts, that is horizontal battery mount and vertical battery mount.

DW.5.2 1: “Horizontal Battery Mount”, its the battery mount where the battery is horizontal to the ground, and is mostly used in the small to medium vehicles likes cars.

DW.5.2 2: “Vertical Battery Mount”, its the battery mount where the battery is vertical to the ground, and is mostly used in the large to heavy vehicles likes trucks, heavy machinery.

DW.6 Drawing 6: Connector and battery change unit

DW.6.1 Drawing 6: Connector and battery change unit.

DW.6.2 1: “Connector and battery charge unit”, this is the logical unit of this sub system, and is responsible for taking actions from the attached system and convert into precision movements, which are directed to the governor. This unit is hosted into different sub systems which are responsible for loading unloading the batteries, or connectors etc. Primarily with the governor, tool arm, tool selection, this unit is able to attach or detach the connectors and batteries.

DW.6.3 2: “Governor” is the rotating motor mechanism which governs the tool arm, tool selection, and the “tool arm” movement is also governed by governor, with special torque detection can detect to what level a tool needs to be tightened. Governor is also equipped with precision laser to pin point, the tool arm and do precision movements.

DW.6.4 3; “Tool arm and tool selector” is the tool selector, which can equip a wide variety of tool bits and tools, used to attach detach the connectors, and batteries. The tool arm can also work on special design “trade secret” connectors which are specifically designed to work with the tool arm.

DW.7 Drawing 7: Example extra storage battery unit

DW.6.1 Drawing 6: Shows example extra storage battery unit

DW.6.2 1: shows the example truck of a vehicle, hosting a extra storage battery.

DW.6.2 2; show the extra storage battery.

DW.6.2 3; shows the connectors attached to the vehicle and the battery.

### DESCRIPTION

### DETAILED DESCRIPTION OF THE INVENTION

P.1 The idea is to create smart electric vehicle battery store and electric vehicle extra storage battery, for battery operated electric automobiles, battery operated electric vehicles, battery operated electric drones, battery operated electric airplanes, battery operated electric boats, battery operated electric devices, battery operated trucks, battery operated heavy machinery can significantly increase the range, and with a smart automatic mechanism to replace the drained battery with a fully charged one, or attach or detach an extra battery storage, on a slow moving or stationary vehicle.

P.2 As detailed in the description, using this novel and innovative technology, this invention will remove the short comings of the electric vehicles or drones etc, with respect to its range of travel and how fast the batteries get charged.

P.3 Extra storage battery can be utilized on need basis using the battery store, and a typical use case might be to use it at the start of the long trip and give it back at the end of the trip.

P.4 It will be possible for the electric vehicles to have a much longer range, and based on the range selected, right extra storage battery can be automatically attached.

P.5 Using the extra battery storage it will be possible to take off road trips and venture into the areas which do not have the required infrastructure of electric recharging.

P.6 It will be possible for the vehicle to get fully charged and back on road within seconds or minutes. As detailed in the description it will be possible to replace the drained battery of a slow moving vehicle or drone etc also.

P.7 The existing infrastructure of the “gas stations” can be used as such, and with slight modifications, it can service the electric vehicles or drones etc, of all makes and kinds.

P.8 The smart battery store will have all kinds of batteries and extra storage batteries where anybody can readily come in and take advantage of.

P.9 The battery store will be particularly useful for to be created battery operated electric heavy machines, battery operated electric trucks, battery operated long range electric vehicles, battery operated electric drones, battery operated electric airplanes and battery operated electric boats.

P.10 The “smart battery store” (SBS) is a smart system which has an array of batteries, having the complete inventory of the batteries, controlling the charging of the batteries, automatic loading and unloading of the batteries. Further the store will have smart extra battery storage (SEBS) of different shapes, sizes and types. For a given a vehicle or drone etc, the store can find the right charged battery, unload it and load the drained battery.

P.11 Smart battery store can be installed in a home, in an industry, city, or an service station of its own.

P.12 Smart extra storage battery, can be of different shapes and sizes, and can be added in the vehicle truck space, the frunk space (forward truck), as a top rack, as under the car as attachment, or under the seats of the cars. The exact shape and size can be of the shape and size of the available space, ranging from 100 cm to 50 m.

P.13 Extra storage trailer batteries (ESTB), which are very big batteries and can have its own powered propel unit, as an trailer to the vehicle, and will significantly increasing the battery capacity and range and be able to charge the depleted battery of the vehicle to which it is attached.

P.14 (SBS) can be installed in a home, in an industry, city, or an service station of its own.

P.15 SBS can be on a floating boat and SBSF.

P.16 SBS can be on flying aircraft and is SBSF

P.17 Battery Size range: The SBS hosts batteries ranging from 10 nm (nano meters) to 500 m (meters). Further using the composable battery technology as referred in other patent can create composable batteries in that range.

P.18 Voltage, Amperes and Ampere hours ranges: The SBS hosts batteries ranging from 0.1 V to 22,000 V, and from 0.1 Amperes to 100,000 Amperes. Further SBS has batteries from 1 AH to 500,000 AH.

P.19 As the goal of the system is to achieve highest Interoperability, the libraries of the system is implemented in multiple programming languages. java, c #, objective c. The interfaces written in cross platform frameworks, with mobile responsive. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the battery management systems and system as such. The system also uses mysql, Postgres, file system along with very secure hash safe custom native persistent data structures, and data lake. Also as the system is implemented as SAAS in multi region, communication between its different multi region SAAS, across different geographies and countries.

P.20 Glossary:
SBS: smart battery store
SESB: smart extra storage battery
SARCBOMSV: smart mechanism to automatic replace and change installed battery or extra storage battery of the slow moving or stationary vehicle
SBSF: is floating smart battery store
SBSFL: is flying smart battery store
ESTB: is extra storage trailer batteries

D.1 Detailed description and working of (SBS)

D.1.1 The smart battery store for electric vehicles works primarily on secondary battery types. The “smart battery store” (SBS) is an smart system which has an array of batteries, having the complete inventory of the batteries, controlling the charging of the batteries, automatic loading and unloading of the batteries. Further the store will have smart extra battery storage (SEBS) of different shapes, sizes and types. For a given a vehicle or drone etc, the store can find the right charged battery, unload it and load the drained battery.

D.1.2 (SESB) can be installed in a home, in an industry, city, or an service station of its own.

D.1.3 The key functions of the smart battery stores for electric vehicles are:
I. Inventories of batteries, the capacity of the batteries, voltage ratings, usage, charge cycles, compatible vehicles, range of vehicles.
II. Hold the batteries, with the unique automatic battery storage and retrieval mechanism.
III. Charge the batteries
IV. Have logic which batteries fit which vehicle or devices
V. Automatic loading and unloading of the batteries
VI. Detailed workflow and logic on how to load batteries on electric automobiles and electric motorcycles
VII. Detailed workflow and logic on how to load batteries on on electric drones
VIII. Detailed workflow and logic on how to load batteries on on electric powered airplanes
IX. Detailed workflow and logic on how to load batteries on on electric powered boats
X. Detailed workflow and logic on how to load batteries on on electric powered trucks
XI. Detailed workflow and logic on how to load batteries on on electric powered long range vehicles
XII. Detailed workflow and logic on how to load batteries on on electric powered heavy machinery

D.1.4 The system holds the information of the all the batteries, extra storage batteries, their dimensions, ratings, vehicle, which batteries are compatible with which vehicles, and know how workflow, action steps for the replacement of the batteries and the configuration of the same. It holds the information of all the assemblers and there working using sub modules. Further all the assemblers interact with the the system and sub system to create the required batteries. It also holds the inventory of all the composable batteries, connector types and different parts at each location and for each battery creator (assembler, de-assember). It is the central logical unit to which the individual aggregators, and battery assemblers connect to. Further it comprises of different sub parts as described below.

D.1.5 SBSF: is floating smart battery store

D.1.6 SBSFL: is flying smart battery store

D.1.7 The smart battery store for electric vehicles also calls for special manufacturing practice but does not mandates where the vehicles are manufactured with detachable batteries, as such the batteries can be attached or detached. Where the detachable battery compartments can be vertical or horizontal.

D.1.8 The vehicles, gadgets and devices the store services are:
I. battery operated electric automobiles,
II. battery operated electric vehicles,
III. battery operated electric drones,
IV. battery operated electric airplanes,
V. battery operated electric boats,
VI. battery operated electric devices,
VII. Battery operated electric drones
VIII. Battery operated motorcycles
IX. Battery operated trucks
X. Battery operated heavy machinery

D.1.9 Drawing 1: Shows, smart electric vehicle battery store (SBS) and system, further as duplicated in section D.1.

D.1.10 1 “Central Battery Store Management System”, comprises of computer logic and system programming, for the complete system and provides the complete overview of the system. Further as described in section D.1

D.1.11 2 “Workflow and Action Engine”, the workflow and action engine holds the workflow of battery retrieval and placement unit, and the workflow of battery attachment, detachment unit, it also holds the sets as actions which needs to be performed by the unit to complete the action. Based on the workflow based on the vehicle and job, exacts steps are sent to automatic battery retrieval and placement to pick the right battery and replace it in the vehicle, drone or boat. Further as depicted in section D.1

D.1.12 3 is “Electric Vehicle Battery Store”, is the typical storage unit which holds the electric batteries, further as described in the diagram 2 below, the store has logical computation also which governs, the chaining of the batteries, the health of the batteries and other metrics.

D.1.13 4 is “Automatic Battery Placement and Retrieval”, this sub system is responsible for automatic placement of the battery in the battery store and the automatic retrieval of the battery from the battery store, further the sub unit is responsible for detaching the battery or extra storage battery to electric vehicles, electric trucks, other electric devices, it relies on the central system for workflow and exact steps, configuration. Further as described in Diagram 3 and section D.5.

D.1.14 5 is “Automatic Battery Replacement Mechanism” is sub system is responsible for detaching the battery or extra storage battery to electric vehicles, electric trucks, other electric devices, it is special in a way it can operate on slow moving vehicles also.

D.1.15 6 is “Integration API”, the central API which all the systems use to interact with one another, further all the individual sub systems do expose APIs about their functionality, stats and working.

D.1.16 Drawing 2: Shows, example electric Vehicle Battery Store for storage electric vehicle batteries and extra storage batteries. A battery store is normally hosted in a building, floating platform or boat, large sized locomotive and is made of smaller compartments, where an example compartment section is described here. Further as described in D.2.

D.1.17 1 is “Battery Holder and Charging Compartments” these are modular design compartments which holds the batteries as they charge up, they can be of different size and shapes as defined by the size and shapes of the batteries.

D.1.18 2 “Vertical Connectors”, are the vertical connectors for the batteries to connect on to.

D.1.19 3 “Governor” is the logical electric unit which controls the charge of the battery, inventory of the slot, the connector types, battery types, voltage step up, step down, ampere, voltage and battery charging status, battery health.

D.1.20 4 “Horizontal Connectors”, are the vertical connectors for the batteries to connect on to.

D.2 Detailed description and working of working of extra battery storage (SEBS)

D.2.1 Smart extra storage battery (SESB), that can be added to the vehicle as an extra battery, than what is already installed, leading to increase in the battery capacity

D.2.2 Smart extra storage battery, can be of different shapes and sizes, and can be added in the vehicle truck space, the frunk space (forward truck), as a top rack, as under the car as attachment, or under the seats of the cars.

D.2.3 Extra storage trailer batteries (ESTB), which are very big batteries and can have its own powered propel unit, as an trailer to the vehicle, and will significantly increasing the battery capacity and range and be able to charge the depleted battery of the vehicle to which it is attached.

D.2.4 Further extra storage batteries can be attached on some of the following:
I. truck,
II. frunk (front trunk),
III. in the top rack
IV. Under the seat
V. In the container of a truck
VI. Hood of the electric boat
VII. On electric drones
VIII. On electric airplanes

DD.2.5 Drawing 6: Shows example extra storage battery unit

D.2.6 1: shows the example truck of a vehicle, hosting a extra storage battery.

D.2.7 2; show the extra storage battery.

D.2.8 3; shows the connectors attached to the vehicle and the battery.

D.3 Detailed description and working of working of smart mechanism to automatic replace and change installed battery or extra storage battery of the slow moving or stationary vehicle SARCBOMSV

D.3.1 Smart mechanism to automatic replace and change installed battery or extra storage battery of the slow moving or stationary vehicle (SARCBOMSV), where the drained battery of the vehicle will be replaced with a charged battery, that is, drained installed battery or extra storage battery, will be taken out or detached and the charred battery or extra storage battery, is inserted in or attached.

D.3.2 This sub system which gets its instructions, workflow, and actions steps from the central system. The system works automatically, and works on composable battery units (secondary batteries). The sub system is able to get the appropriate parts, compostable batteries units of right voltage, amperes, size and type, get the right compatible connectors, space bars, connectors strips, and battery containers, and assemble the battery of appropriate rating as configuration sent from the central system and instructed by the operator. It relies on other sub systems as further described below.

D.3.3 A typical workflow is described below.
I. Scan the incoming vehicle for battery compatibility
II. Send the request to the central system, get instructions for workflow and steps
III. Request and special range or other requests
IV. Find the appropriate make, model, rating and range for the battery
V. For the found batteries find the one with full charge
VI. Initialize automatic unload of the battery
VII. Determine stationary or slow moving vehicle
VIII. Initialize slow moving mechanism or stationary vehicle mechanism
IX. Determine vertical or horizontal battery loading mount on the vehicle
X. Open/Unload the battery compartment for the vehicle, for slow moving vehicle active auxiliary power supply till the new battery is being loaded
XI. Unlock connectors and unload the drained battery
XII. Load the fully charged battery
XIII. Lock the connectors
XIV. Signal the vehicle job complete and clear to depart
XV. Take the drained battery to the appropriate storage slot to get charged

D.3.4 SARCBOMSV which can work on extra storage batteries.

D.3.5 SARCBOMSV can work on ESTB and can attach, de-attach the same to low slow moving or stationary vehicle within seconds or minutes. SFARCBOMSV, which is flying SARCBOMSV SFLARCBOMSV, which is floating SARCBOMSV

D.3.6 Drawing 3: Shows automatic Battery Placement and Retrieval unit which is responsible for automatic placement of the battery in the battery store and the automatic retrieval of the battery from the battery store, further the sub unit is responsible for detaching the battery or extra storage battery to electric vehicles, electric trucks, other electric devices.

D.3.7 1 “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it. The governor receives the instructions based on the current workflow, and has exact series of steps to follow to complete the job. This unit is equipped with laser for exact positioning and movement.

D.3.8 2 “Vertical Control Arm”, is the vertical control arm which moves the assembly up and down, and on its axis. It uses the technology that exists as of today for similar vertical movement arms, using hydraulics, and line wires.

D.3.9 3 “Length Adjuster”, is the vertical control arm extension which can further adjust the length and increase the vertical reach.

D.3.10 4 “Horizontal Control Arm”, is the horizontal control arm which can move the assembly to and fro horizontally.

D.3.11 5 “Object Fork”, control fork which move, hold, place, objects, batteries, both in the battery store, and use the attached units to connect to the connectors and at the same time attach or detach to the vehicle.

D.3.12 6: “Adjustable and sliding tightening mechanism”, is mechanism comprising of adjustable screws for tightening, it can operate while the “object fork” holds an object in a certain position.

D.3.13 7: “Connector and Battery change unit”, is the control mechanism which can change a connector or battery unit.

D.3.14 Drawing 4: Shows, automatic battery replacement for stationary or slow moving vehicles, attaching, detaching the batteries to the vehicles, is sub system which is responsible for detaching the battery or extra storage battery to electric vehicles, electric trucks, other electric devices, it is special in a way it can operate on slow moving vehicles also.

D.3.15 1: “Battery Retrieval Placement Unit” is responsible for holding the battery or extra storage battery unit and positioning it to either retrieve it or place it to, on the vehicles.

D.3.16 2; “Connector and Battery change unit”, is the control mechanism which can change a connector or battery unit.

D.3.17 3: “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it. The governor receives the instructions based on the current workflow, and has exact series of steps to follow to complete the job. The unit is specially equipped with the laser to adjust the speed on the sub unit to match the speed of the vehicle and change the battery on slow moving vehicle. This unit is equipped with laser for exact positioning and movement.

D.3.18 4: is “Lift” which is hydraulic based lift mechanism which is used to lift up or down the the “Battery Retrieval Placement Unit”, to replace the battery or extra storage battery.

D.3.19 5: “Adjustable and sliding tightening mechanism”, is mechanism comprising of adjustable screws for tightening, it can operate while the “object fork” holds an object a certain position.

D.3.20 Drawing 6: Connector and battery change unit.

D.3.21 1: “Connector and battery charge unit”, this is the logical unit of this sub system, and is responsible for taking actions from the attached system and convert into precision movements, which are directed to the governor. This unit is hosted into different sub systems which are responsible for loading unloading the batteries, or connectors etc. Primarily with the governor, tool arm, tool selection, this unit is able to attach or detach the connectors and batteries.

D.3.22 2; “Governor” is the rotating motor mechanism which governs the tool arm, tool selection, and the “tool arm” movement is also governed by governor, with special torque detection can detect to what level a tool needs to be tightened. Governor is also equipped with precision laser to pin point, the tool arm and do precision movements.

D.3.23 3; “Tool arm and tool selector” is the tool selector, which can equip a wide variety of tool bits and tools, used to attach detach the connectors, and batteries. The tool arm can also work on special design “trade secret” connectors which are specifically designed to work with the tool arm.

D.6. Detailed description with architectural diagrams and drawings, working of integration between different sub systems

D.6.1 As the goal of the system is to achieve highest Interoperability, the libraries of the system is implemented in multiple programming languages. java, c #, objective c. The interfaces written in cross platform frameworks, with mobile responsive. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the battery management systems and system as such. The system also uses mysql, Postgres, file system along with very secure hash safe custom native persistent data structures, and data lake. Also as the system is implemented as SAAS in multi region, communication between its different multi region SAAS, across different geographies and countries.

1. Claim to invent and create smart electric vehicle battery store (SBS) and system for battery operated electric automobiles, battery operated electric vehicles, battery operated electric drones, battery operated electric airplanes, battery operated electric boats, battery operated electric devices, battery operated electric trucks, battery operated electric heavy vehicles.

2. Claim to invent and create electric vehicle extra storage battery for battery operated electric automobiles, battery operated electric vehicles, battery operated electric drones, battery operated electric airplanes, battery operated electric boats, battery operated electric devices, battery operated electric trucks, battery operated electric heavy vehicles, that can be added to the vehicle as an extra battery, than what is already installed, leading to increase in the battery capacity

3. Claim to invent and create, smart automatic mechanism to replace the drained battery with a fully charged one, or attach or detach an extra battery storage, on a slow moving or stationary vehicle (SARCBOMSV), where the drained battery of the vehicle will be replaced with a charged battery, that is, drained installed battery or extra storage battery, will be taken out or detached and the charred battery or extra storage battery, is inserted in or attached.
